(19) United States
(12) Patent Application Publication
(10) Pub. No.: US 2023/0296489 A1
(43) Pub. Date: Sep. 21, 2023

(54) FLOW CELL AND SAMPLE SORTING SYSTEM

(71) Applicant: Elephas Biosciences Corporation, Madison, WI (US)

(72) Inventors: Wesley A. Cox-Muranami, Middleton, WI (US); Todd Bakken, Madison, WI (US); David Michael Wahl, Madison, WI (US); Justine Coburn, Madison, WI (US); Christian Baltes, Madison, WI (US)

(21) Appl. No.: 18/123,069

(22) Filed: Mar. 17, 2023

Related U.S. Application Data
(60) Provisional application No. 63/321,466, filed on Mar. 18, 2022.

(51) Int. Cl. G01N 15/14; B01L 3/00

(52) U.S. Cl. CPC G01N 15/1404; G01N 15/1436; B01L 3/502715; G01N 2015/149; B01L 2200/0652; B01L 2300/0663; B01L 2400/06

(57) ABSTRACT

A sorting system including a flow cell with a first inlet, a second inlet, and an outlet. The sorting system also includes a buffer supply in fluid communication with the first inlet, a sample source in fluid communication with the second inlet, a light source configured to generate a light beam that intersects the flow cell, and a sensor aligned with the light source and configured to detect a characteristic of the light beam. An air valve is configured to generate an airflow at the outlet of the flow cell, and control of the air valve is based on the characteristic of the light beam detected by the sensor.

### RELATED APPLICATIONS

The present application claims priority to U.S. Provisional Application No. 63/321,466, filed Mar. 18, 2022, which is incorporated herein by reference in its entirety.

### FIELD

The present disclosure provides systems, devices, and methods related to sorting samples. In some embodiments, the systems, devices, and methods related to sorting tissue samples that find use in tissue culture and drug testing applications.

### BACKGROUND

Existing tissue sample or fragment sorters are expensive, unreliable, and include superfluous features. Samples (e.g., tissue samples, tissue fragments, targets, or particles of interest) need to be quickly and consistently sorted and are too small and numerous to be reasonably sorted by hand (e.g., manually).

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure provides a sorting system including a flow cell with a first inlet, a second inlet, and an outlet. The sorting system further includes a buffer supply in fluid communication with the first inlet; a sample source in fluid communication with the second inlet; a light source configured to generate a light beam that intersects the flow cell; and a sensor aligned with the light source and configured to detect a characteristic of the light beam. The sorting system further includes an air valve configured to generate an airflow at the outlet of the flow cell; wherein control of the air valve is based on the characteristic of the light beam detected by the sensor.

In some embodiments, the sorting system further includes a sample collection stage aligned with the outlet.

In some embodiments, the sample collection stage includes a plate with a well, and the sample source includes a sample fluid with a plurality of targets. The sorting system is configured to place one or more of the plurality of targets in the well.

In some embodiments, the well is one of a plurality of wells and the sorting system is configured to place one of the plurality of targets in each of the plurality of wells.

In some embodiments, the sample collection stage includes an actuator coupled to the plate, and the plate is movable with respect to the outlet of the flow cell in response to activation of the actuator.

WM In some embodiments, the airflow moves fluid from the outlet of the flow cell to a waste collection.

In some embodiments, the waste collection includes a shroud and the outlet of the flow cell is positioned within the shroud.

In some embodiments, the shroud includes an aperture aligned with the outlet of the flow cell.

In some embodiments, the sorting system further includes a pressure source in fluid communication with each of the buffer supply, the sample source, and the air valve.

In some embodiments, the light source is a laser.

In some embodiments, a profile of the light beam is linear.

In some embodiments, the sample source includes a sample fluid with a plurality of targets, and the sample fluid flows from the second inlet to the outlet and passes through the light beam. The plurality of targets blocks a portion of the light beam from reaching the sensor.

In some embodiments, the sorting system further comprises a camera configured to capture an image of the plurality of targets as the plurality of targets move through the flow cell.

In some embodiments, the characteristic of the light beam is transmission.

In some embodiments, control of the air valve is based on a time-of-flight analysis of the light characteristic.

In some embodiments, a flow of fluid through the flow cell is paused in response to the sensor detecting a change in the characteristic of the light beam; and a fixed amount of liquid is dispensed from the outlet of the flow cell after the pause.

In some embodiments, a flow rate of fluid through the flow cell is continuous.

In some embodiments, the sorting system further includes a first flow sensor and a first valve fluidly positioned between the buffer supply and the flow cell, and a second flow sensor and a second valve positioned between the sample source and the flow cell.

In some embodiments, the first valve is controlled based on a first flow detected by the first flow sensor; and wherein the second valve is controlled based on a second flow detected by the second flow sensor.

In some embodiments, the sorting system further includes a mixing assembly coupled to the sample source, wherein the mixing assembly is configured to move the sample source.

In some embodiments, the mixing assembly includes a base, a carrier configured to receive the sample source, and an actuator coupled to the carrier. The carrier rotates about an axis in response to activation of the actuator.

In some embodiments, the sample source includes a protrusion configured to create a turbulent flow of a sample fluid within the sample source in response to rotation about the axis.

In some embodiments, the sorting system further includes a lens aligned with the light beam and positioned between the light source and the flow cell.

In some embodiments, the sorting system is configured to sort at least 20 samples per minute.

In some embodiments, the sorting system further includes a temperature-controlled system thermally coupled to the buffer supply, the sample source, the sample collection stage, or any combination thereof.

In some embodiments, the flow cell further includes a third inlet and the system further comprises an auxiliary supply in fluid communication with the third inlet.

In some embodiments, the auxiliary supply is a cleaning solution, a disinfectant, or any combination thereof.

In some embodiments, the sorting system further includes an identifying fiducial coupled to the flow cell and a sensor configured to detect the identifying fiducial.

Another aspect of the present disclosure provides a flow cell including a first chamber, a sheath fluid inlet aperture in fluid communication with the first chamber, and a second chamber in fluid communication with the first chamber. The second chamber is smaller than the first chamber. The flow cell further includes an outlet channel in fluid communication with the second chamber, and a sample nozzle extending at least partially into the second chamber. The sample nozzle includes a sample channel. The flow cell further includes a sample fluid inlet aperture in fluid communication with the sample channel. At least a portion of the outlet channel includes an observation region.

In some embodiments, the outlet channel defines an axis, and the axis extends through the second chamber and the first chamber.

In some embodiments, the sample channel is aligned with the axis, and the axis extends through the sample fluid inlet aperture.

In some embodiments, the second chamber has a conical portion, and the outlet channel extends from the conical portion.

In some embodiments, the flow cell further includes an auxiliary inlet aperture in fluid communication with the first chamber.

In some embodiments, the flow cell further includes a first window coupled to a first side of the observation region and a second window coupled to a second side of the observation region.

In some embodiments, the first window and the second window are made of glass or cyclic olefin copolymer.

In some embodiments, flow through the sheath fluid inlet aperture is a first flow rate and flow through the sample fluid inlet aperture is a second flow rate lower than the first flow rate.

In some embodiments, a ratio of the second flow rate to the first flow rate is 1:10.

In some embodiments, the ratio is adjusted based on a size of samples in a sample fluid.

In some embodiments, the sample nozzle divides a flow of sheath fluid and the sample flow is positioned within the flow of sheath fluid.

In some embodiments, the flow cell is a single-use device.

In some embodiments, the flow cell is made of polypropylene, polycarbonate, cyclic olephin copolymer, or thermo plastic vulcanizates.

Another aspect of the present disclosure provides a flow cell including a substrate and a first channel formed in the substrate. The first channel has a first width. The flow cell also includes a sheath fluid inlet aperture in fluid communication with the first channel, a splitter positioned in the first channel, and a second channel formed in the substrate and in fluid communication with the first channel. The second channel has a second width smaller than the first width. The flow cell further includes a sample fluid inlet aperture in fluid communication with the second channel, and an outlet in fluid communication with the second channel. At least a portion of the second channel includes an observation region.

In some embodiments, the flow cell further includes a first window coupled to a first side of the substrate at the observation region.

In some embodiments, the flow cell further includes a second window coupled to a second side of the substrate at the observation region.

In some embodiments, the first window and the second window are made of glass or cyclic olefin copolymer.

In some embodiments, the first window and the second window are overmolded onto the substrate.

In some embodiments, the first window extends to the outlet.

In some embodiments, the flow cell further includes a first lid coupled to the first side of the substrate.

In some embodiments, flow through the sheath fluid inlet aperture is a first flow rate and flow through the sample fluid inlet aperture is a second flow rate lower than the first flow rate.

In some embodiments, a ratio of the second flow rate to the first flow rate is 1:10.

In some embodiments, the ratio is adjusted based on a size of samples in a sample fluid.

In some embodiments, the outlet is formed in a beveled tip and the beveled tip includes a hydrophobic coating.

In some embodiments, the splitter divides a flow of sheath fluid into a first sheath stream and a second sheath stream, and the sample flow is positioned between the first sheath stream and the second sheath stream.

In some embodiments, the first channel extends along a channel axis and the second channel extends along the channel axis.

In some embodiments, the flow cell further includes a sheath fluid inlet bore in fluid communication with the sheath fluid inlet aperture, the sheath fluid inlet bore extends from a second side of the substrate to the first channel along a first bore axis.

In some embodiments, the first bore axis is perpendicular to the channel axis.

In some embodiments, the flow cell further includes a sample fluid inlet bore in fluid communication with the sample fluid inlet aperture. The sample fluid inlet bore extends from the second side of the substrate to the splitter along a second bore axis.

In some embodiments, the first bore axis is parallel to the second bore axis.

In some embodiments, the first channel and the second channel are positioned on a plane.

In some embodiments, the flow cell is a single-use device.

In some embodiments, the flow cell is made of polypropylene, polycarbonate, cyclic olephin copolymer, or thermo plastic vulcanizates.

In some embodiments, the flow cell includes a third channel formed in the substrate and in fluid communication with the second channel at a junction.

In some embodiments, the junction is downstream of the observation region.

In some embodiments, a valve is positioned at the junction.

### BRIEF DESCRIPTION OF THE DRAWINGS

The accompanying figures and examples are provided by way of illustration and not by way of limitation. The foregoing aspects and other features of the disclosure are explained in the following description, taken in connection with the accompanying example figures (“FIG.”) relating to one or more embodiments.

FIG. 1 is a schematic of a sorting system including a flow cell.

FIG. 2 is a perspective view of an optics assembly and a flow cell of a sorting system.

FIG. 3 is a perspective view of the flow cell of FIG. 2.

FIG. 4 is an exploded view of the flow cell of FIG. 3.

FIG. 5 is an enlarged view of a portion of the flow cell of FIG. 3.

FIG. 6 is a perspective view of a portion of the flow cell of FIG. 3.

FIG. 7 is a perspective view of a flow cell.

FIG. 8 is a perspective view of a flow cell.

FIG. 9 is a perspective view of a flow cell.

FIG. 10 is a plan view of a sample positioned within a flow cell.

FIG. 11A is a side view of an outlet of the flow cell with an airflow from an air valve moving fluid to a waste collection.

FIG. 11B is a side view of the outlet of the flow cell with no airflow from the air valve and fluid containing a sample moving to a sample collection stage.

FIG. 12 is a top view of a single target sample (e.g., a tissue sample) sorted into a well of a sample collection stage.

FIG. 13 is a perspective view of a mixing assembly and a sample source.

FIG. 14 is a perspective view of an optics assembly and a flow cell of a sorting system.

FIG. 15 is a perspective view of the flow cell of FIG. 14 with a waste collection shroud and an air nozzle.

FIG. 16 is a perspective view of a cross-section of the flow cell, the waste collection shroud, and the air nozzle of FIG. 15.

FIG. 17 is an exploded view of the flow cell of FIG. 14.

### DETAILED DESCRIPTION

Unless otherwise defined, all technical and scientific terms used herein have the same meaning as commonly understood by one of ordinary skill in the art. The meaning and scope of the terms should be clear; in the event, however of any latent ambiguity, definitions provided herein take precedent over any dictionary or extrinsic definition.

Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. Unless otherwise required by context, singular terms shall include pluralities and plural terms shall include the singular. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

“About” and “approximately” are used to provide flexibility to a numerical range endpoint by providing that a given value may be “slightly above” or “slightly below” the endpoint without affecting the desired result.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “top” and “bottom”, “front” and “rear”, “inner” and “outer”, “above”, “below”, “upper”, “lower”, “vertical”, “horizontal”, “upright” and the like are used as words of convenience to provide reference points.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

“Subject” as used herein is any mammalian or non-mammalian subject. In some embodiments, the subject is a human subject. In some embodiments, the subject is suspected of or diagnosed with cancer. The cancer can be any solid or hematologic malignancy. The cancer can be of any stage and/or grade. Non-limiting examples of cancer include cancers of head & neck, oral cavity, breast, ovary, uterus, gastro-intestinal, colorectal, pancreatic, prostate, brain and central nervous system, skin, thyroid, kidney, bladder, lung, liver, bone and other tissues.

“Tissue” or “tissue sample” as used interchangeably herein, is a biological material obtained from a subject. The tissue can be from any organ or site in the body of the subject. A tissue can be obtained from a subject by any approach known to a person skilled in the art. The tissue can be obtained by surgical resection, surgical biopsy, investigational biopsy or any other therapeutic or diagnostic procedure performed on a subject. In some embodiments, the tissue contains or is suspected to contain tumor cells. The terms tumor cells, cancerous cells, and malignant cells have been used interchangeably. In some embodiments, the tissue is a tumor tissue. In some embodiments, the tissue is obtained from any organ or site in the body of the subject where a cancer has originated or where the cancer has metastasized to. In some embodiments, the tissue may also contain immune cells, stromal cells etc. While the tissue can be in any form (such as frozen or fixed), in preferred embodiments, the tissue is a live, fresh tissue. In some embodiments, the tissue has not been subjected to any tissue fixation techniques known to a person of ordinary skill in the art (such as formalin treatment) or not been stored under any condition or for any duration of time to significantly reduce the number of viable cells.

Tissue fragments are fragments of the tissue sample that have detached from the tissue sample, wherein the fragments are obtained by cutting the tissue in one or more dimensions. In some embodiments, the tissue fragments are obtained by cutting the tissue sample in all three dimensions, such as a first dimension, a second dimension, and a third dimension. In some embodiments, (such as in the case of a biopsy tissue sample) where the tissue sample already has the desired sizes in two dimensions, tissue fragments can be produced by cutting the tissue sample in only one dimension. The tissue fragments can be of various shapes, with non-limiting examples of shapes including cubes, square cuboids, rectangular cuboids, cylindrical, parallelogram prisms and the like.

In some embodiments, the tissue fragments are substantially cubical in shape. In some embodiments, the size of each tissue fragment is equal to or less than 1000 μm (such as 1000 μm, 500 μm, 450 μm, 400 μm, 350 μm, 300 μm, 250 μm, 200 μm, 100 μm or 50 μm) in at least one dimension. In some embodiments, sample sizes are larger than approximately 1000 μm in one or more dimensions. In some embodiments, the size of each tissue fragment is between 50 μm and 1000 μm in at least one dimension. In some embodiments, the size of each tissue fragment is between 100 μm and 500 μm in at least one dimension. In some embodiments, the size of each tissue fragment is between 150 μm and 350 μm in at least one dimension. In some embodiments, the size of each tissue fragment is between 50 μm and 500 μm (such as 50 μm, 100 μm, 150 μm, 200 μm, 250 μm, 300 μm, 350 μm, 400 μm, 450 μm or 500 μm) in at least two dimensions. In some embodiments, the size of each tissue fragment is between 100 μm and 350 μm in at least two dimensions. In some embodiments, the size of each tissue fragment is between 50 μm and 500 μm in all three dimensions. In some embodiments, the size of each tissue fragment is between 100 μm and 350 μm in all three dimensions. In some embodiments, each tissue fragment is between 300 μm and 350 μm in two dimensions and between 100 μm and 150 μm in a third dimension. In some embodiments, the tissue fragments are uniform in size. As used herein, uniform means substantially uniform, wherein the size of the tissue fragments are within ±30% of one another, in at least one dimension. In some embodiments, the tissue fragments are live tissue fragments, wherein the cutting processes did not substantially reduce the number of viable cells that were present in the tissue sample. In some embodiments, the tissue fragments are live tissue fragments, such that one or more functional assays can be performed on the tissue fragments. A specified size is the desired size of a tissue fragment in one or more dimensions. The specified size can be user-defined or pre-defined depending on tissue type and/or end application. According to one or more embodiments, the tissue cutting system cuts the tissue sample into tissue fragments of a specified size. The size of the tissue fragments is specified in one or more dimensions. In some embodiments, the tissue cutting system cuts the tissue into tissue fragments as per sizes specified in all three dimensions. As used herein, a tissue fragment of a specified size does not necessarily imply that the tissue fragment has the same size in all dimensions. For example, the tissue fragment of a specified size can have the same size in all three dimensions (such as 300 μm×300 μm×300 μm), it can have the same size in two dimensions and a different size in the third dimension (such as 300 μm×300 μm×100 μm), or it can have different sizes in all three dimensions. Tissue fragments that are cut in sizes greater than or less than the specified size (such as in one, two or all three dimensions), depending on the end application, are unwanted tissue fragments. In some embodiments, tissue fragments within ±50% of the specified size (in one or more dimensions) can still be usable or are desired tissue fragments. For example if the specified size is 300 μm×300 μm×300 μm, tissue fragments with a size of 450 μm in one or more dimensions might still be within the range of specified size (hence desired tissue fragments), however, tissue fragments with size exceeding 450 μm in one or more dimensions might be outside the range of the specified size and hence are unwanted tissue fragments. The size that is acceptable within the range of specified size may be user defined based on the application.

As used herein, the term “processor” (e.g., a microprocessor, a microcontroller, a processing unit, or other suitable programmable device) can include, among other things, a control unit, an arithmetic logic unit (“ALC”), and a plurality of registers, and can be implemented using a known computer architecture (e.g., a modified Harvard architecture, a von Neumann architecture, etc.). In some embodiments the processor is a microprocessor that can be configured to communicate in a stand-alone and/or a distributed environment, and can be configured to communicate via wired or wireless communications with other processors, where such one or more processor can be configured to operate on one or more processor-controlled devices that can be similar or different devices.

As used herein, the term “memory” is any memory storage and is a non-transitory computer readable medium. The memory can include, for example, a program storage area and the data storage area. The program storage area and the data storage area can include combinations of different types of memory, such as a ROM, a RAM (e.g., DRAM, SDRAM, etc.), EEPROM, flash memory, a hard disk, a SD card, or other suitable magnetic, optical, physical, or electronic memory devices. The processor can be connected to the memory and execute software instructions that are capable of being stored in a RAM of the memory (e.g., during execution), a ROM of the memory (e.g., on a generally permanent bases), or another non-transitory computer readable medium such as another memory or a disc. In some embodiments, the memory includes one or more processor-readable and accessible memory elements and/or components that can be internal to the processor-controlled device, external to the processor-controlled device, and can be accessed via a wired or wireless network. Software included in the implementation of the methods disclosed herein can be stored in the memory. The software includes, for example, firmware, one or more applications, program data, filters, rules, one or more program modules, and other executable instructions. For example, the processor can be configured to retrieve from the memory and execute, among other things, instructions related to the processes and methods described herein.

As used herein, the term “network” generally refers to any suitable electronic network including, but not limited to, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some embodiments, the network is a cellular network, such as, for example, a Global System for Mobile Communications (“GSM”) network, a General Packet Radio Service (“GPRS”) network, an Evolution-Data Optimized (“EV-DO”) network, an Enhanced Data Rates for GSM Evolution (“EDGE”) network, a 3GSM network, a 4GSM network, a 5G New Radio, a Digital Enhanced Cordless Telecommunications (“DECT”) network, a digital AMPS (“IS-136/TDMA”) network, or an Integrated Digital Enhanced Network (“iDEN”) network, etc.

In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet).

Conventional flow cells utilized in conventional flow cytometers are expensive with multiple styles of regions (e.g., sheath generation, imaging, etc.) that require complicated fabrication processes not suitable for high volume production. Conventional sheath flow systems develop three-dimensional cones for sheath flow with a centered sample tube. Conventional three-dimensional sheath design requires special manufacturing processes tailored for the three-dimensional fluidic form factor.

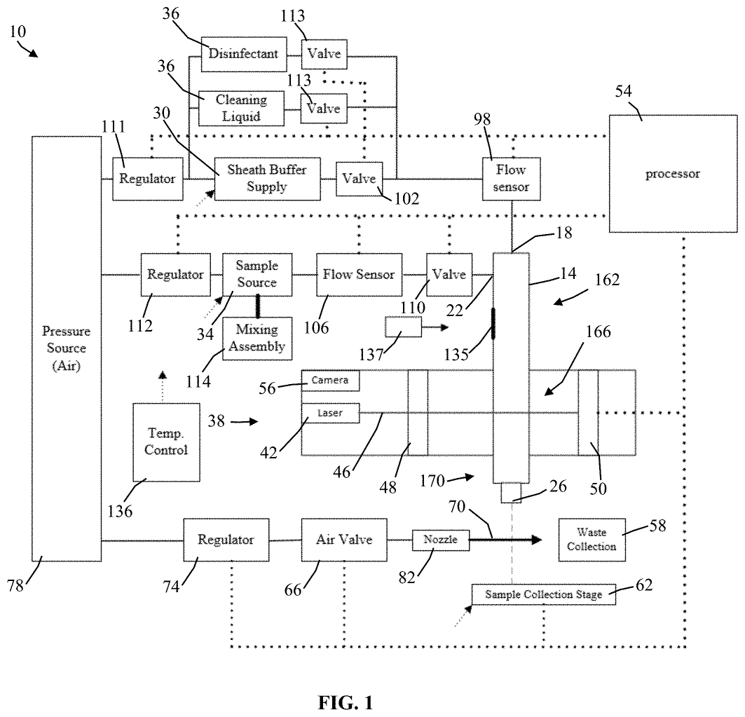

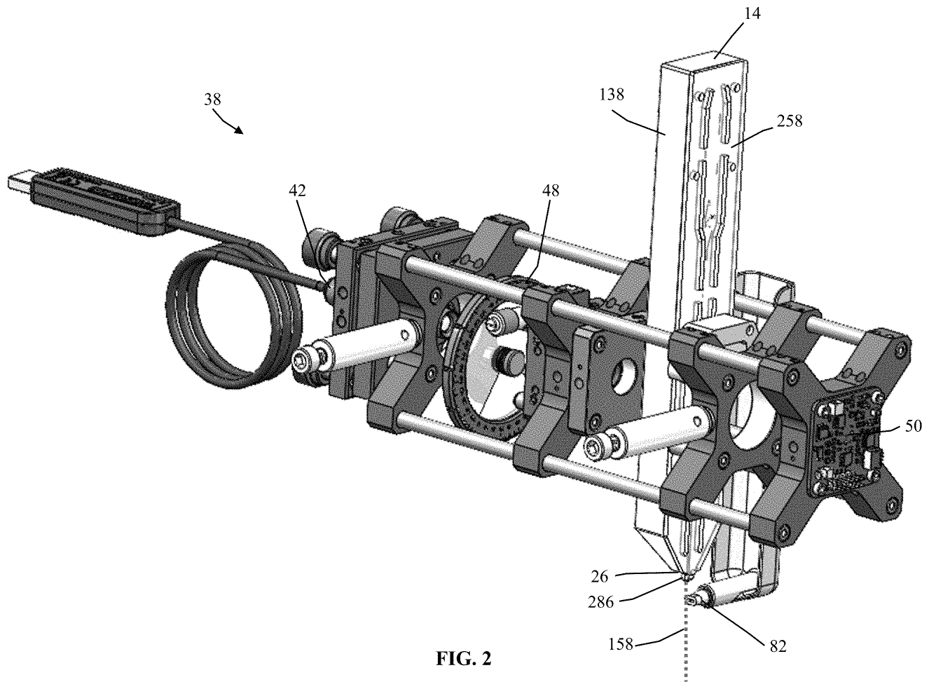

With reference to FIG. 1, a sorting system 10 with a flow cell 14 is illustrated. The flow cell 14 includes a first inlet 18, a second inlet 22, and an outlet 26. As described herein, the sorting system 10 achieves sorting of samples (e.g., tissue samples, tissue fragments, targets, particles of interest) based on, for example, optical characteristics, sample size, and/or sample opacity.

The sorting system 10 includes a buffer supply 30 (e.g., a sheath fluid) in fluid communication with the first inlet 18 of the flow cell 14 and a sample source 34 (e.g., a sample fluid) in fluid communication with the second inlet 22 of the flow cell 14. In some embodiments, the buffer supply 30 includes phosphate buffered saline (PBS), Dulbecco's phosphate buffered saline (DPBS), Iscove's Modified Dulbecco's Medium (IMDM), or some combination thereof. In some embodiments, the sample source 34 includes a sample fluid with a plurality of targets (e.g., samples, tissue fragments, targets, etc.). In other words, the plurality of targets are suspended within the sample fluid. In some embodiments, the sample fluid is L-15 media. In some embodiments, the sample fluid contains the same fluid as the buffer supply. In some embodiments, the sample source 34 is provided by a cutting apparatus or cutting system that creates a plurality of fragments from a larger sample.

With reference to FIG. 1, the sorting system 10 includes an optics assembly 38 with a light source 42 configured to generate a light beam 46 that intersects the flow cell 14. In some embodiments, the light source 42 is a laser and the light beam 46 is a laser beam. In some embodiments, a profile of the light beam is linear. An example of a linear profile includes a rectangular-shaped light beam. In other words, the light beam cross-section forms a line. Advantageously, a light beam with a linear profile is more easily aligned to overlap with a region of interest. In the illustrated embodiment, the optics assembly 38 also includes a lens 48 aligned with the light beam 46 and positioned between the light source 42 and the flow cell 14.

The optics assembly 38 also includes a sensor 50 aligned with the light source 42 and configured to detect a characteristic of the light beam 46. In some embodiments, the sensor 50 is a photodiode. In the illustrated embodiment, the laser beam 46 passes through the flow cell 14 and is detected by the sensor 50. In other words, the flow cell 14 is mounted between the light source 42 and the sensor 50. The sensor 50 is electronically coupled to a processor 54 (FIG. 1) such that the processor 54 is configured to receive an output signal from the sensor 50. In some embodiments, the characteristic of the light beam 46 detected by the sensor 50 is transmission (e.g., optical transmission). As explained in greater detail herein, sample fluid from the sample source 34 flows from the second inlet 22 to the outlet 26 of the flow cell 14 and passes through the light beam 46. The plurality of targets within the sample fluid blocks a portion of the light beam 46 from reaching the sensor 50, corresponding to a detectable change in the sensor 50 output signal to the processor 54. In some embodiments, the processor 54 performs a time-of-flight analysis (e.g., determining the amount of time the sample blocks or changes the light beam 46, and/or determining how much of the light beam is blocked) of the light characteristic. In some embodiments, the time-of-flight analysis can be used to determine a size of the sample passing through the light beam 46. Determining the size of the sample advantageously enables sorting samples by size. In some embodiments, the sorting system 10 further includes a camera 56 configured to capturing an image of the plurality of targets as the plurality of targets flow through the flow cell 14.

In other embodiments, the characteristic of the light beam 46 detected by the sensor 50 is spectral power distribution or intensity. In some embodiments, the light beam 46 is an excitation light and the sensor detects fluoresced light at a different wavelength than the excitation light.

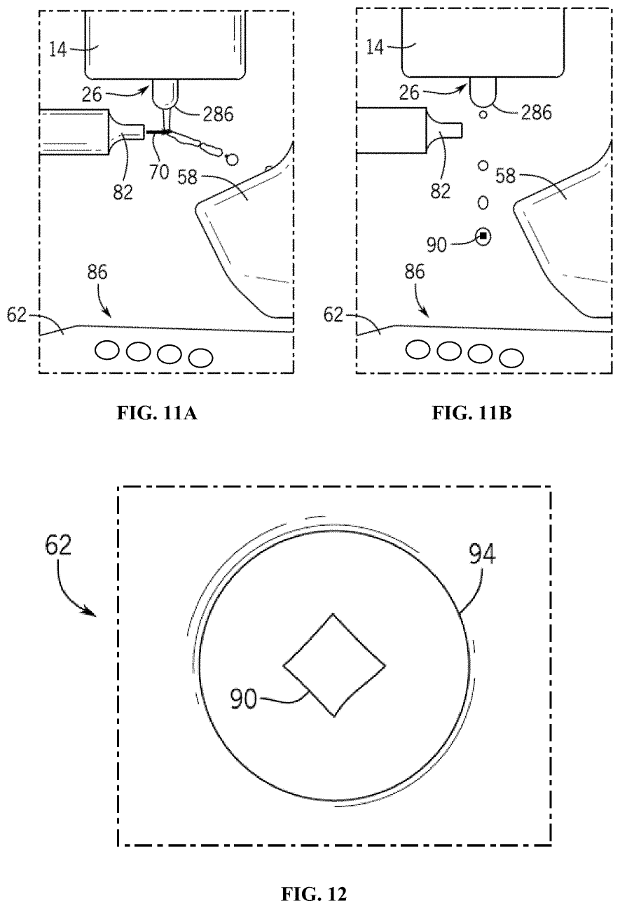

Fluid exiting the outlet 26 of the flow cell 14 is controlled, as described herein, to move to a waste collection 58 (e.g., when the sample fluid contains no target) or a sample collection stage 62 (e.g., when the sample fluid contains a target), based on optical properties or characteristics detected with the optics assembly 38. In the illustrated embodiment, the waste collection 58 is positioned adjacent to the outlet 26 and positioned vertically between the outlet 26 and the sample collection stage 62. In other words, the waste collection 58 is positioned below and to the side of the outlet 26 (see, for example, FIGS. 11A and 11B).

In some embodiments, the flow of the fluid through the flow cell 14 is paused in response to the sensor 50 detecting a change in the characteristic of the light beam 46. In some embodiments, the flow of fluid through the flow cell 14 is paused in response to the sensor 50 detecting a threshold amount in the characteristic of the light beam 46. After the pause in fluid flow through the flow cell 14, a fixed amount of liquid (e.g., 3-15 μL) is dispensed from the outlet 26 of the flow cell 14. In other words, the flow rate of fluid through the flow cell 14 is discontinuous during operation of the sorting system 10. Advantageously, the discontinuous flow from the outlet 26 of the flow cell 14 provides adequate time to position an identified sample in a desired location. In other embodiments, the flow rate of fluid through the flow cell 14 is continuous during operation of the sorting system 10.

With reference to FIG. 1, the sorting system 10 includes an air valve 66 configured to generate an airflow 70 (FIG. 11A) at the outlet 26 of the flow cell 14. In the illustrated embodiment, a regulator 74 is fluidly positioned between a pressure source 78 (e.g., a source of pressurized air) and the air valve 66. The pressure source 78 is in fluid communication with the air valve 66. In the illustrated embodiment, a nozzle 82 is fluidly coupled to the air valve 66, and the nozzle 82 is oriented toward the outlet 26 of the flow cell 14. In some embodiments, the air valve 66 is electronically controlled by the processor 54. In the illustrated embodiment, control of the air valve 66 is based on the characteristic of the light beam 46 detected by the sensor 50. In some embodiments, control of the air valve 66 is based on a time-of-flight analysis of the light characteristic. In the illustrated embodiment, the selective airflow 70 from the air valve 66 moves fluid exiting the outlet 26 of the flow cell 14 to the waste collection 58 (FIG. 11A). In other words, the airflow 70 from the air valve 66 (and correspondingly the pressure source 78) moves fluid leaving the flow cell 14 to the waste collection 58 because there are no targets (e.g., samples, fragments, particles of interest, etc.) detected by the sensor 50 in the fluid.

With reference to FIGS. 1, 11A, and 11B, the sample collection stage 62 is vertically aligned below the outlet 26 of the flow cell 14. In other words, fluid leaving the outlet 26 is acted upon by gravity to move towards the sample collection stage 62. In some embodiments, the sample collection stage 62 is a well plate (e.g., a plate with a plurality of wells 86). In some embodiments, the sample collection stage 62 is a single well (e.g., a conical tube). In some embodiments, the sample collection stage is an individual container including, for example, a 50 mL conical tube, a 1.5 ml tube, a petri dish, and other suitable containers.

As described herein, the sample source 34 includes a sample fluid with a plurality of targets for sorting, and the sorting system 10 is configured to place one or more of the plurality of targets in a well. In some embodiments, the well is one of a plurality of wells 86 and the sorting system 10 is configured to place one of the plurality of targets in each of the plurality of wells. In some embodiment, the sorting system 10 is configured to place no more than one target in each of the plurality of wells 86. With reference to FIG. 12, a single sample 90 is shown positioned within a single well 94 as a result of the sorting system 10 operation.

In some embodiments, the sample collection stage 62 includes an actuator coupled to the plate and the plate is movable with respect to the outlet 26 of the flow cell 14 in response to activation of the actuator. In some embodiments, the sample collection stage 62 is movable by an actuator and is controlled by the processor 54 to align individual wells vertically below the outlet 26 of the flow cell 14. For example, once a target or a plurality of targets is placed within a well, the plate is moved to realign another well with the outlet 26. In some embodiments, the sorting system 10 is configured to sort at a rate of at least 20 samples per minute. In some embodiments, the sorting system 10 is configured to sort at a rate within a range of approximately 30 samples per minute to approximately 60 samples per minute. In some embodiments, the sorting system 10 is configured to sort at a rate within a range of approximately 100 samples per minute to approximately 150 samples per minute. In some embodiments, the sorting system 10 is configured to sort at a rate of approximately 2 samples per second to approximately 3 samples per second. The sorting rate is dependent on, among other things, how concentrated the sample is and the sorting accuracy desired.

With continued reference to FIG. 1, in the illustrated embodiment, the pressure source 78 is in fluid communication with each of the buffer supply 30, the sample source 34, and the air valve 66. In some embodiments, a first flow sensor 98 and a first valve 102 are fluidly coupled and positioned between the buffer supply 30 and the flow cell 14. In some embodiments, a second flow sensor 106 and a second valve 110 are fluidly coupled and positioned between the sample source 34 and the flow cell 14. In the illustrated embodiment, the first flow sensor 98 and the second flow sensor 106 are electrically coupled to the processor 54 and configured to provide an output signal to the processor 54 representative of a flow rate (e.g., a buffer fluid flow rate, a sample fluid flow rate). In the illustrated embodiment, the first valve 102 and the second valve 110 are electrically coupled to the processor 54 and configured to open and close in response to control signals from the processor 54. In some embodiments, the first valve 102 is controlled by the processor 54 based on a first flow rate detected by the first flow sensor 98, and the second valve 110 is controlled by the processor 54 based on a second flow rate detected be the second flow sensor 106. In other words, the buffer fluid system and/or the sample fluid system is closed loop controlled for a desired flow rate. In other embodiments, the fluid system is closed loop controlled for a desired pressure. In some embodiments, a regulator 111 is fluidly coupled between the buffer supply 30 and the pressure source 78, and a regulator 112 is fluidly coupled between the sample source 34 and the pressure source 78. In some embodiments, the regulators 111, 112 are electrically coupled to the processor 54.

With continued reference to FIG. 1, in the illustrated embodiment, at least one auxiliary supply 36 is in fluid communication with the flow cell 14. In the illustrated embodiment, the auxiliary supply 36 is routed in parallel with the sheath buffer supply 30 and the auxiliary supply 36 can be used in combination with or in place of the sheath buffer supply 30. Advantageously, the parallel auxiliary supplies 36 also for easy switching of the sheath fluid in the flow cell. In some embodiments, the auxiliary supply 36 is a cleaning solution, a detergent, a disinfectant, an alternative buffer, a nutrient solution, or any combination thereof. The auxiliary supply 36 is controlled by a valve 113 electrically coupled to the processor 54. In some embodiments, there are any number of parallel auxiliary supplies.

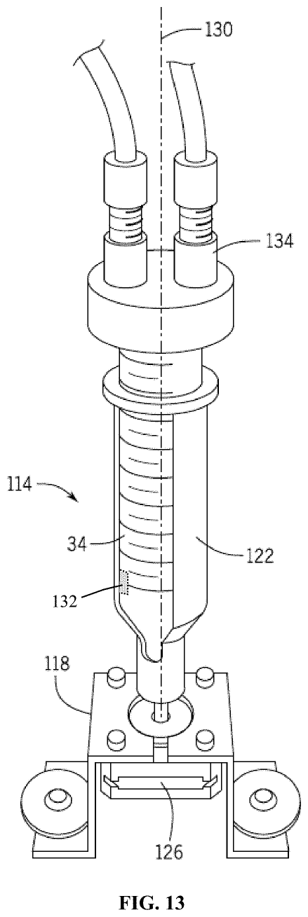

With reference to FIGS. 1 and 13, the sorting system 10 further includes a mixing assembly 114 mechanically coupled to the sample source 34. The mixing assembly 114 is configured to move the sample source 34. The mixing assembly 114 agitates, moves, stirs, etc. the sample fluid in the sample source 34 to advantageously suspend the plurality of targets within the sample fluid, which results in more even flow through the flow cell 14. In the illustrated embodiment, the mixing assembly 114 includes a base 118, a carrier 122 configured to receive the sample source 34, and an actuator 126 coupled to the carrier 122. With reference to FIG. 13, the carrier 122 rotates about an axis 130 in response to activation of the actuator 126. In some embodiments, the sample source 34 includes a protrusion 132 extending into the sample fluid to create a turbulent flow of the sample fluid in response to rotation about the axis 130. In some embodiments, the protrusion is a tube (e.g., an uptake tube 134) fluidly coupled to the sample source 34. In other words, the tubing that transports the sample fluid from the sample source 34 to the flow cell 14 may also serve as the protrusion for generating turbulent flow within the sample source 34.

In some embodiments, the sorting system 10 includes laboratory information management system (LIMS). Inputs to the LIMS may include manual inputs (e.g., user information, location information, target number of fragments per well), barcode inputs (e.g., sorting input vessel, sheath buffer bottle, wash buffer bottle, well plate, consumable flow cell), or cloud inputs (e.g., tumor fragment size, tumor tissue type, timings for steps). Outputs to the LIMS may include actual (e.g., sorted fragments in a well plate) and system log files (e.g., warnings, errors, start time, stop time, sort parameters, flow rates, pressures, fragment capture window, expected number of fragments per well, data of all fragments that went through system, data linking specific fragment data to each well).

In some embodiments, the sorting system 10 includes a temperature-controlled system 136 thermally for controlling the temperature of other components of the sorting system 10 (FIG. 1 indicates thermal coupling of the temperature-controlled system 36 to various components of the sorting system with dashed arrows). In some embodiments, the temperature-controlled system is thermally coupled to the buffer supply 30, the sample source 34, the sample collection stage 62, or any combination thereof. In some embodiments, the temperature-controlled system includes a circulated heat exchange fluid.

In some embodiments, the sorting system 10 includes an identifying fiducial 135 coupled to the flow cell 14, for example, and a sensor 137 configured to detect the identifying fiducial 135. In some embodiments, the identifying fiducial 135 is a RFID tag, a QR code, a barcode, or any other suitable electronic or optical tag. In some embodiments, the identifying fiducial 135 is automatically detected by the sensor 137 and the sorting system 10 is configured automatically. Advantageously, this ensures the flow cell 14 installed in the sorting system 10 is appropriate for the sample source 34 loaded. In some embodiments, an identifying fiducial is positioned on other components of the sorting system such as the sample inlet tube, sheath container, or any other consumable. Advantageously, this allows the sorting system 10 to confirm everything is positioned properly and any consumable have not expired, for example.

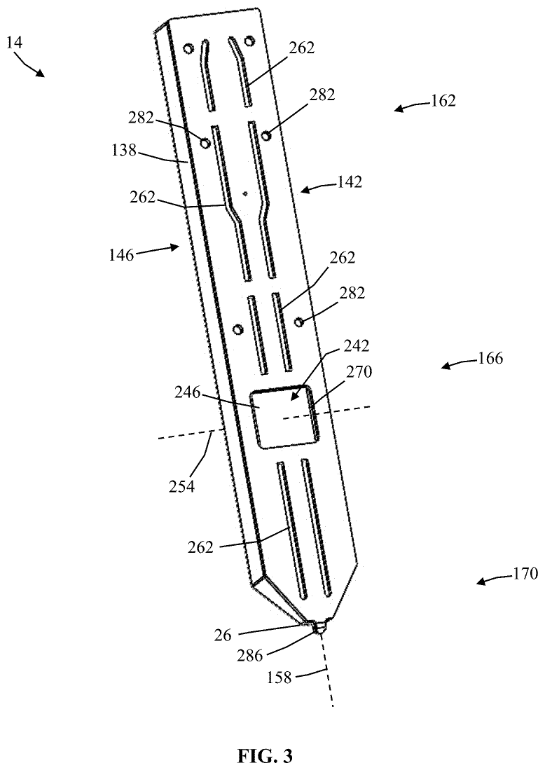

With reference to FIGS. 3-6, the flow cell 14 includes a substrate 138 with a first side 142 and a second side 146 opposite the first side 142. In the illustrated embodiment, a first channel 150 and a second channel 154 are formed in the first side 142 of the substrate 138. The second channel 154 is in fluid communication with the first channel 150. In the illustrated embodiment, the first channel 150 and the second channel 154 extend along a channel axis 158. In other words, the first channel 150 and the second channel 154 are aligned along the axis 158. In some embodiments, the first channel 150 and the second channel 154 extend along and are positioned on a single common plane. In other words, the first channel 150 and the second channel 154 are co-planar.

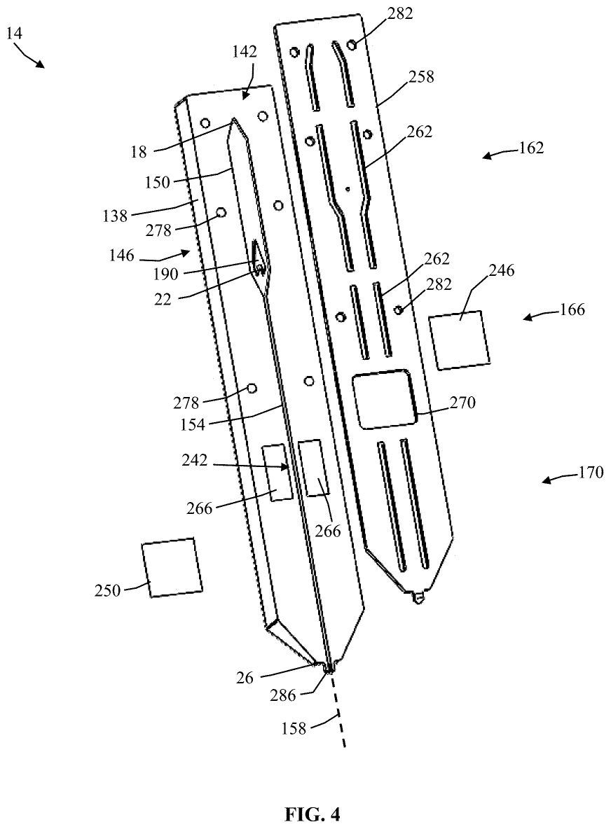

With reference to FIGS. 3 and 4, the flow cell 14 generally includes a sheath flow generation zone 162, an imaging zone 166, and an exit zone 170. In the illustrated embodiment, the imaging zone 166 is downstream of the sheath flow generation zone 162 and upstream of the exit zone 170. In other words, the imaging zone 166 is positioned between the sheath flow generation zone 162 and the exit zone 170.

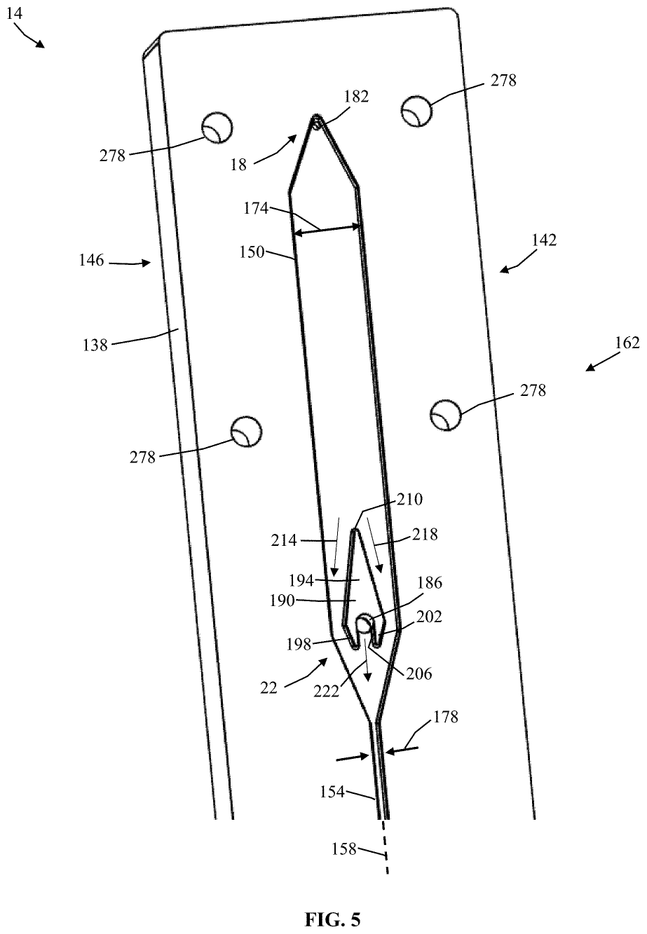

With reference to FIG. 5, in the illustrated embodiment, the first channel 150 has a first width 174 and the second channel 154 has a second width 178 that is smaller than the first width 174. The first inlet 18 of the flow cell 14 includes a sheath fluid inlet aperture 182 in fluid communication with the first channel 150. The second inlet 22 of the flow cell 14 includes a sample fluid inlet aperture 186 in fluid communication with the second channel 154.

With continued reference to FIG. 5, a splitter 190 is positioned in the first channel 150. In the illustrated embodiment, the splitter 190 extends into the first channel 150 and separates the flow of sheath fluid from the buffer supply 30. In the illustrated embodiment, the splitter 190 includes a triangular-shaped portion 194, a first rib 198, and a second rib 202, with a slot 206 formed between the first rib 198 and the second rib 202. A point 210 of the triangular-shaped portion 194 is oriented toward the sheath fluid inlet aperture 182. In the illustrated embodiment, the point 210 is positioned between the sheath fluid inlet aperture 182 and the sample fluid inlet aperture 186. In the illustrated embodiment, the sample fluid inlet aperture 186 is positioned within the slot 206 of the splitter 190. As described herein, the splitter 190 divides a flow of sheath fluid into a first sheath stream 214 and a second sheath stream 218, and then a sample flow 222 is introduced and positioned between the first sheath stream 214 and the second sheath stream 218.

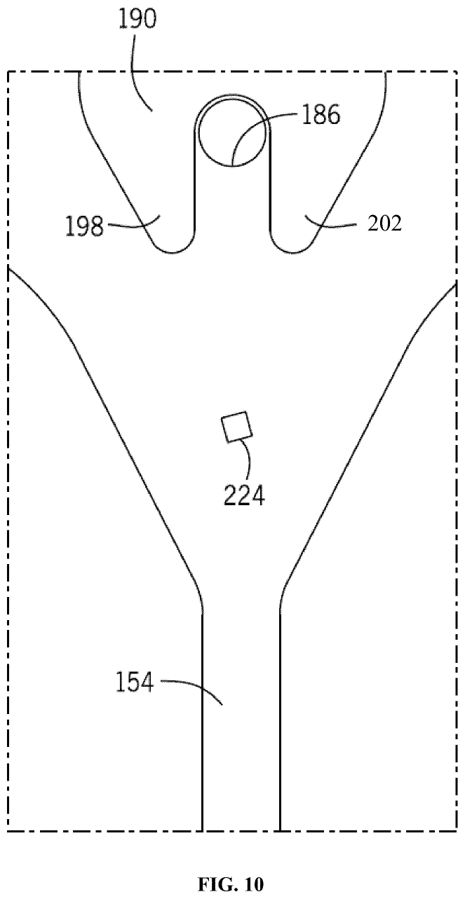

The sheath generation zone 162 combines two different flows of different fluids—the sheath fluid at a high flow rate and the sample fluid at a lower flow rate. The function of the sheath fluid is to encompass the sample fluid, keeping the sample fluid away from walls of the channels 150, 154 and centering the contents of the sample flow, which carries the samples to be analyzed by the sorting system 10. The sorting system 10 is agnostic to the size of the particles to be sorted as long as they fit within the tube and channel dimensions of the flow cell 14. In some embodiments, the sheath fluid and the sample fluid will be the same tissue fragment-friendly buffer such as PBS, DPBS, IMDM or the like. The sheath flow is located “before” the sample flow and has space to achieve a steady state flow. A bifurcation (e.g., the splitter 190) in the first channel 150 then causes the sheath to split into two streams 214, 218. At the end of the bifurcation resides the sample fluid inlet aperture 186. Directly downstream of the sample fluid inlet aperture 186, all three fluidic paths 214, 218, 222 converge with the two sheath flows 214, 218 surrounding the sample flow 222. With reference to FIG. 10, a sample 224 suspended in the sample flow is shown downstream of the sample fluid inlet aperture 186, and the sample 224 is centered with respect to the second channel 154 by the sheath fluid.

The flow through the sheath fluid inlet aperture 182 is a first flow rate and the flow through the sample fluid inlet aperture 186 is a second flow rate lower than the first flow rate. In some embodiments, the first flow rate is approximately 30 mL/min and the second flow rate is approximately 3 mL/min. In some embodiments, the first flow rate is approximately 25 mL/min. In some embodiments, a ratio of the second flow rate to the first flow rate is approximately 1:10. In some embodiments, the ratio is adjusted based on a size of targets (e.g., samples) in a sample fluid. In other words, the ratio can be adjusted to create a larger or smaller sample flow profile within the sheath flow, which is important when trying to avoid damaging the fragments by forcing them to squeeze into flows that are smaller than their profiles.

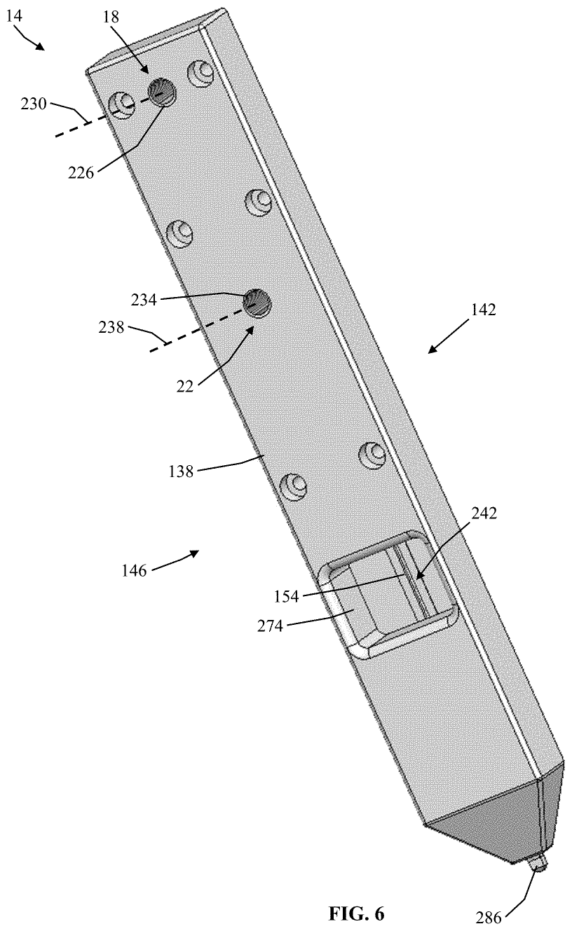

With reference to FIG. 6, the flow cell 14 includes a sheath fluid inlet bore 226 in fluid communication with the sheath fluid inlet aperture 182. In some embodiments, the sheath fluid inlet bore 226 extends from the second side 146 of the substrate 138 to the first channel 150 along a first bore axis 230. In the illustrated embodiment, the first bore axis 230 is perpendicular to the channel axis 158. The flow cell 14 also includes a sample fluid inlet bore 234 in fluid communication with the sample fluid inlet aperture 186. The sample fluid inlet bore 234 extends from the second side 146 of the substrate 138 to the splitter 190 along a second bore axis 238. In the illustrated embodiment, the first bore axis 230 is parallel to the second bore axis 238.

With continued reference to FIG. 4, an observation region 242 is in the imaging zone 166. In the illustrated embodiment, the observation region 242 is positioned fluidly downstream of the splitter 190 and upstream of the outlet 26. At least a portion of the second channel 154 includes and extends through the observation region 242. In the illustrated embodiment, the observation region 242 is positioned between the sample fluid inlet aperture 186 and the outlet 26. The observation region 242 is distanced far enough away from the sheath flow generation zone 162 to ensure the steady state combination flow of both the sheath and sample is achieved for predictable and reproducible positioning of sample as it passes through the observation region 242.

The flow cell 14 further includes a first window 246 coupled to the first side 142 of the substrate 138 at the observation region 242, and a second window 250 coupled to a second side 146 of the substrate 138 at the observation region 242. In the illustrated embodiment, at the observation region 242, the second channel 154 includes two side walls formed in the substrate 138 and is bounded on two other sides by the windows 246, 250. The flow cell 14 includes a discontinuity in the second channel 154 by subtracting the top and base of the second channel 154, and in its place a different, more optically transparent material (e.g., the windows 246, 250) is mounted to the substrate 138. In other words, the flow cell 14 includes an open second channel 154 that is sealed with optically transparent materials (e.g., windows 246, 250). The observation region 242 is defined by top and bottom channel surfaces that are designed as optical pathways. In the illustrated embodiment, an imaging axis 254 passes through the flow cell 14 without passing through the substrate 138. The imaging axis 254 intersects the first window 246 and the second window 250. In the illustrated embodiment, the imaging axis 254 is aligned with the light beam 46 of the optics assembly 38.

In some embodiments, the flow cell includes a single window. In some embodiments, the flow cell includes at least one window (e.g., window 246, 250). In some embodiments, the flow cell includes a plurality of observation regions. In some embodiments, the window or windows are made of glass, cyclic olefin copolymer (COP), or other optically transparent materials. In some embodiments, the window or windows are overmolded onto the substrate 138 to directly set their positioning with respect to the substrate 138. In other embodiments, the window or windows are secured to the substate 138 with an adhesive (e.g., Acrylic solvent, UV cured cyanoacrylate, 2 part epoxy).

With continued reference to FIG. 4, the flow cell 14 includes a first lid 258 coupled to the first side 142 of the substrate 138. In the illustrated embodiment, the first lid 258 at least partially encloses the first channel 150 and the second channel 154 formed in the substrate 138. In some embodiments, the first lid is formed as part of the first window. In some embodiments, the first window extends along the first channel 150, the second channel 154, and extends to the outlet 26.

With continued reference to FIG. 4, the first lid 258 includes grooves 262 that extends through the first lid 258 and are configured to receive an adhesive to secure the first lid 258 to the substrate 138. In addition, the substrate 138 includes recesses 266 to receive adhesive to secure the first window 246 to the substrate 138. The first lid 258 includes a cutout 270 to receive the first window 246. The substrate 138 includes a cutout 274 to receive the second window 250. Alignment fiducials 278 are positioned on the substrate 138 and corresponding alignment fiducials 282 are positioned on the first lid 258 to ensure alignment during assembly of the flow cell 14.

With reference to FIG. 4, the outlet 26 of the flow cell 14 is in fluid communication with the second channel 154. The outlet 26 of the flow cell 14 is formed in a beveled tip 286. The beveled tip 286 ensures clean droplet dispensing as the flow exits the outlet 26. Sharp elements that draft to a tip are ideal for this purpose to avoid liquid accumulating at the tip and altering the flow through the exit. In some embodiments, the beveled tip 286 includes a hydrophobic coating. The hydrophobic coating further avoids liquid accumulation and adhesion.

The exit zone 170 of the flow cell 14 enables consistent and predictable placement of fragments into a destination consumable (e.g., the sample collection stage 62) once identified as a target of interest (e.g., by the sensor 50 and processor 54). In some embodiments, the exit zone 170 is made of a different material from the main fluidic substrate 138. The second channel 154 has a length long enough downstream of the observation region 242 to allow the sorting system 10 to react to the identification of a fragment of interest by the sensor 50.

In some embodiments, in response to detecting a fragment of interest, a pause command to the sorting system 10 stops flow through the flow cell 14 before the fragment flows through the outlet 26. In other words, the flow through the flow cell 14 is temporarily halted (e.g., paused, parked) in response to detection of a sample. Once paused, the sorting system 10 then dispenses a volume of liquid (e.g., 3-15 μL) with the fragment to the destination consumable (e.g., the sample collection stage 62) on demand by starting the flow for a short amount of time. As discussed above, portions of fluid that do not carry fragments of interest are diverted into the waste collection 58 via the airflow 70. Conventional sorting systems utilize a continuous, unstopped, flow of fluid through sorting system, which can create difficulty in timing the detection and subsequent placement of a sample of interest. Advantageously, the flow through the flow cell 14 is paused on demand before dispensing a fragment of interest, which allows the sorting system 10 to move as necessary with as much time needed to properly place the sorted fragment.

The flow cell 14 can be utilized as either a permanent fixture on a system or as a consumable to be swapped out regularly. In some embodiments, the flow cell 14 is a single-use device (e.g., consumable, single-use). The features of the flow cell 14 are compatible with consumable fabrication processes such as injection molding, pick and place operations, heat or laser sealing, and automated assembly. In some embodiments, the flow cell 14 is made of polypropylene, polycarbonate, cyclic olephin copolymer, or thermo plastic vulcanizates. Features of the flow cell 14 that advantageously make the flow cell 14 amenable to consumable fabrication techniques are channel size, minimal junction points, and planar style fluidics with features existing either on one side or another of the substrate (rather than several different angles with respect to flow channels). In other words, the flow cell 14 is an integrated two-dimensional design that can be readily made with advantageous consumable fabrication processes.

As described herein, the flow cell 14 is functional subcomponent of the sorting system 10. The flow cell 14 combines three primary fluidic functions that together enable consistent particle flow positioning through the optical assembly (e.g., an optical analysis system) in a manner that does not damage the quality of the particles and allows for on-demand placement of targets (e.g., samples, particles of interest, etc.). The sorting system 10 enables rapid screening of hundreds to thousands of particles of varying sizes and material properties in a consistent manner by directing flow in a predictable manner through known positions. The flow cell 14 provides steady, predictable flow through fluidic junction points with a continuous design that enables undisturbed flow from region to region (e.g., between the sheath flow generation zone 162 and the imaging zone 166). The flow cell 14 advantageously is a continuous flow design with no flow junctions or harsh (drastic) turns to prevent particulates in the flow system from getting stuck on edges.

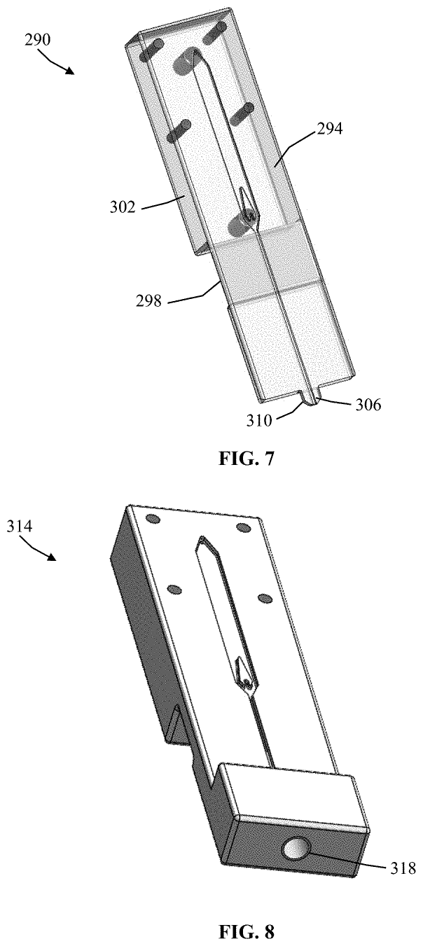

With reference to FIG. 7, a flow cell 290 according to another embodiment is illustrated. The flow cell 290 is lidded with a topside lid 294 and a bottom side lid 298 appended to a substrate 302. The lid 294 completes an exit tip 306 by conforming to the shape of a beveled tip 310 in the substrate 302. The lids 294, 298 are made of optically transparent materials (e.g., glass, COC, polished PMMA, etc.). In some embodiments, the lids 294, 298 are adhesive bounded, solvent bonded, heat welded, or sonic welded onto the substrate 302.

With reference to FIG. 8, a flow cell 314 according to another embodiment is illustrated. The flow cell 314 includes a custom tip port 318 designed as a female connector for standard fluidic connection elements. In some embodiments, the custom tip port 318 includes a luer lock. Advantageously, the flow cell 314 is flexible in the tip shape utilized during operation.

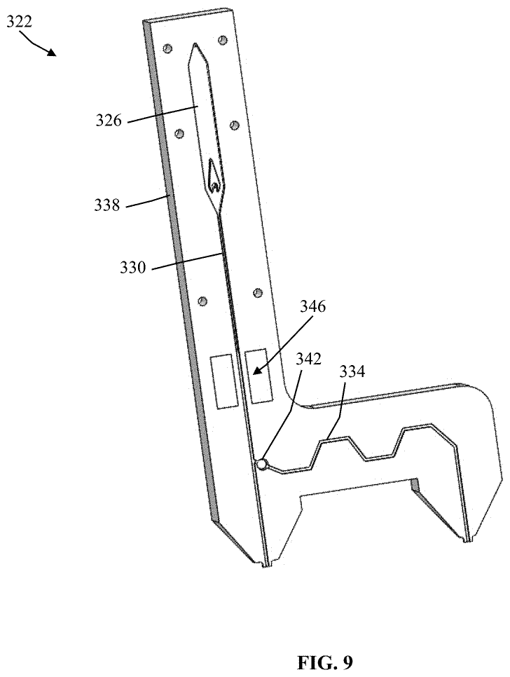

With reference to FIG. 9, a flow cell 322 is illustrated with a first channel 326, a second channel 330, and a third channel 334 formed in a substrate 338. The third channel 334 is in fluid communication with the second channel 330 at a junction 342. In the illustrated embodiment, the junction 342 is downstream of an observation region 346. In some embodiments, a valve is positioned at the junction 342. The flow cell 322 is a cache flow cell. In this dual outlet channel form, there is a bifurcation separating desired fragments from undesired additional elements that happen to reside in the sample fluid. The ideal path may be as long as needed in order to “cache” samples and strategically dispense them to a destination substrate. The additional pathway for undesired elements enables strategic diversion of the elements away from the destination consumable. For the bifurcated design, an air diverter is not required, but rather uses a vacuum pump connected to the exit path. In some embodiments, the third channel 334 is used as a cache channel to store fragments for a bulk dispense. In some embodiments, the third channel 334 is used to reduce the total liquid volume surrounding the fragments, or for a post selection process before ultimately being dispensed into a well plate or other vessel.

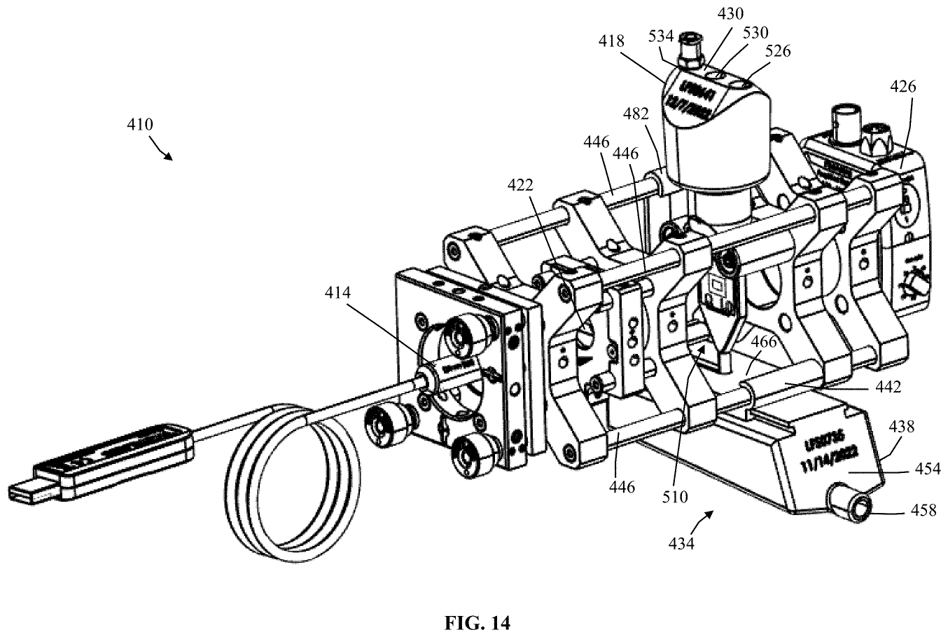

With reference to FIG. 14, an optics assembly 410 is illustrated with a light source 414 configured to generate a light beam that intersects a flow cell 418. In the illustrated embodiment, the optics assembly 410 also includes a lens 422 aligned with the light beam and positioned between the light source 414 and the flow cell 418. The optics assembly 410 also includes a sensor 426 aligned with the light source 414 and configured to detect a characteristic of the light beam. As detailed further herein, the flow cell 418 includes three inlets (e.g., apertures 526, 530, 534) formed in a top surface 430 of the flow cell 418, which permits easy and interchangeable fluid connections to be made to the flow cell 418 that don't interfere with the optics assembly 410.

In the illustrated embodiment, a waste collection 434 is coupled to the optics assembly 410. In particular, the waste collection 434 includes a shroud 438 that is coupled to the optics assembly 410. In the illustrated embodiment, the waste shroud 438 includes clip portions 442 that attach to alignment rails 446 of the optics assembly 410.

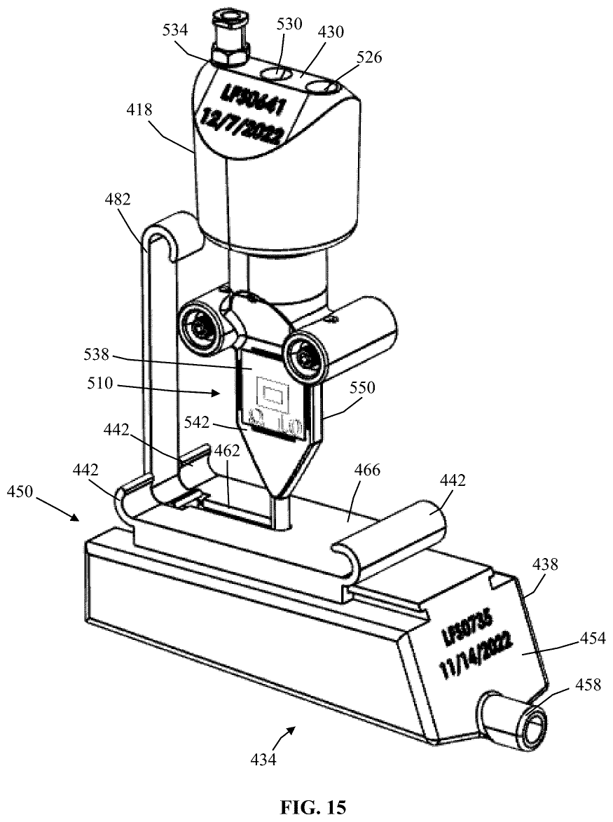

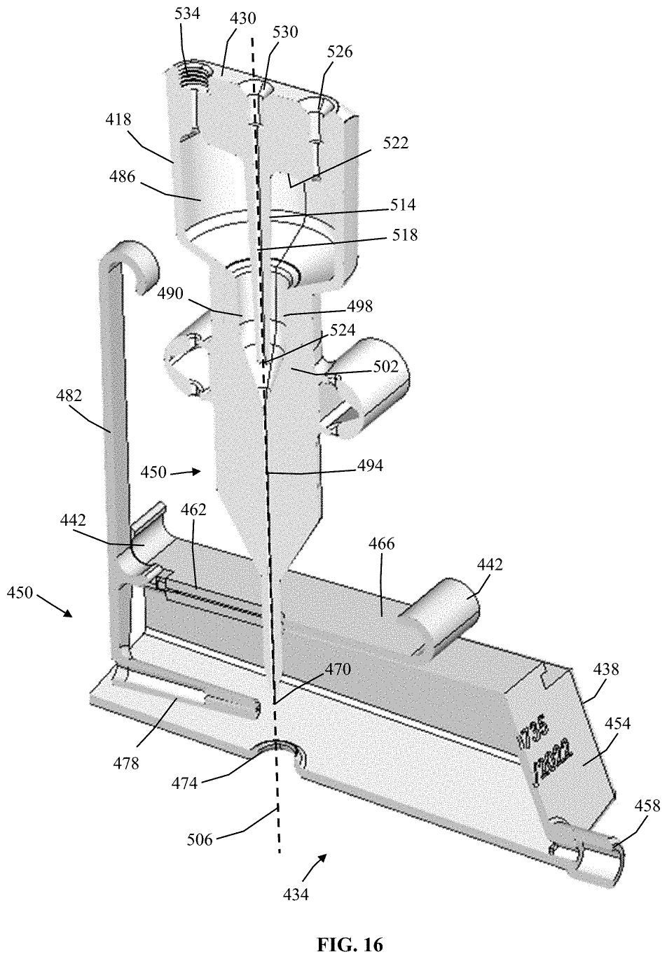

With reference to FIGS. 15 and 16, the shroud 438 includes an open end 450 and a closed end 454 with a fluid outlet 458. In the illustrated embodiment, the shroud 438 further includes a notch 462 formed in an upper surface 466 that is configured to receive a portion of the flow cell 418. In the illustrated embodiment, an outlet 470 of the flow cell 418 is positioned within the shroud 438. The shroud 438 further includes an aperture 474 aligned with the outlet 470 of the flow cell 418. A nozzle 478 is shown extending into the open end 450 of the shroud 438. In the illustrated embodiment, the nozzle 478 includes a bracket 482 that couples the nozzle 478 to the alignment rails 446 of the optics assembly 410. As detailed herein, the nozzle 478 is connected to a controlled source of pressurized fluid (e.g., pressurized air) and blows fluid exiting the flow cell 418 towards the closed end 454 of the shroud 438. The waste liquid then collects at the bottom of the shroud 438 and exits the shroud through the fluid outlet 458. In some embodiments, a tube is connected to the fluid outlet 458 to further direct the waste liquid away.

With reference to FIGS. 15. 16. and 17, the flow cell 418 includes a first chamber 486, a second chamber 490 in fluid communication with the first chamber 486, and an outlet channel 494 in fluid communication with the second chamber 490. In the illustrated embodiment, the second chamber 490 is smaller than the first chamber 486. In other words, the volume of the second chamber 490 is smaller than the volume of the first chamber 486. In the illustrated embodiment, the second chamber 490 has a cylindrical portion 498 and a conical portion 502. The outlet channel 494 extends from the conical portion 502 of the second chamber 490. In other words, the conical portion 502 transitions the cylindrical portion 498 to the outlet channel 494. The outlet channel 494 defines an axis 506 that extends through the second chamber 490 and the first chamber 486. At least a portion of the outlet channel 494 includes an observation region 510.

The flow cell 418 further includes a sample nozzle 514 with a sample channel 518 extending at least partially into the second chamber 490. The sample channel 518 is aligned with the axis 506 of the outlet channel 494. In the illustrated embodiment, the sample nozzle 514 extends from a top surface 522 of the first chamber 486. An outlet 524 of the sample channel 518 is positioned in the second chamber 490. In the illustrated embodiment, the outlet 524 is positioned in the conical portion 502 of the second chamber 490. In the illustrated embodiment, the sample nozzle 514 divides or separates a flow of sheath fluid flowing from the first chamber 486 to the second chamber 490 to position the sample flow within the flow of the sheath fluid. Advantageously, the surrounding sheath fluid centers the sample flow within the outlet channel 494 (e.g., aligned with the axis 506). In other words, the sheath fluid centers the sample flow in at least two dimensions.

In the illustrated embodiment, the flow cell 418 includes a sheath fluid inlet aperture 526, a sample fluid inlet aperture 530, and an auxiliary inlet aperture 534 formed in the top surface 522 of the flow cell 418. As such, the inlets (e.g., apertures 526, 530, 534) are positioned at a first end of the flow cell 418, and the outlet 470 is positioned at a second end, opposite the first end. The sheath fluid inlet aperture 526 is in fluid communication with the first chamber 486. The auxiliary inlet aperture 534 is in fluid communication with the first chamber 486. The sample fluid inlet aperture 530 is in fluid communication with the sample channel 518. In the illustrated embodiment, the axis 506 extends through the sample fluid inlet aperture 530. In some embodiments, the sheath fluid inlet aperture 526 is fluidly coupled to a sheath source (e.g., sheath buffer supply 30), the sample fluid inlet aperture 530 is fluidly coupled to a sample source (e.g., sample source 34), and the auxiliary inlet aperture 534 is fluidly coupled to an auxiliary supply (e.g., auxiliary supply 36), such as a cleaning liquid supply, a disinfectant supply, additional sheath buffer, etc.

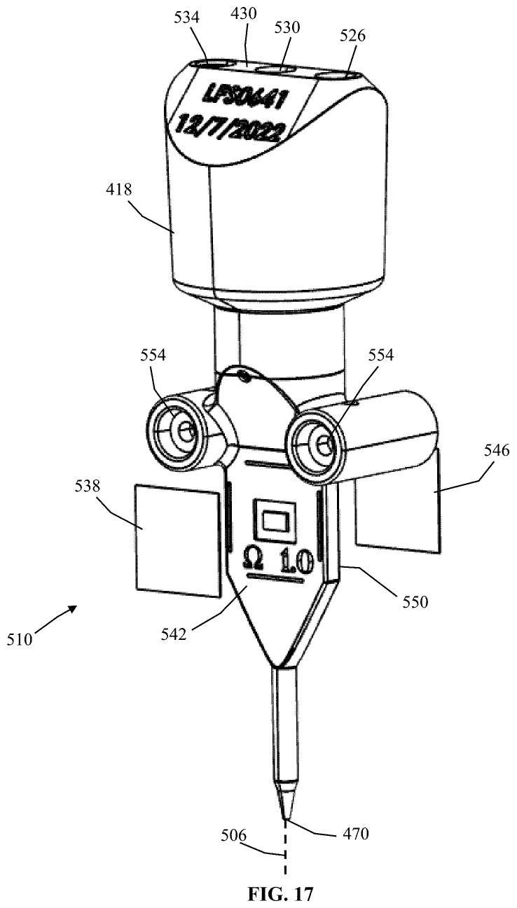

With reference to FIG. 17, the flow cell 418 includes a first window 538 coupled to a first side 542 of the observation region 510 and a second window 546 coupled to a second side 550 of the observation region 510. In some embodiments, the first window 538 and the second window 546 are made of glass or a cyclic olefin copolymer. In the illustrated embodiment, the windows 538, 546 do not form part of the outlet channel 494 in the observation region 510, which advantageously reduces the possibility of leaks occurring. In some embodiments, the entire flow cell 418, except for the windows 538 and 546, is additively manufactured (e.g., 3D printed). In some embodiments, the windows are attached to a 3D printed flow cell with an adhesive (e.g., epoxy). Additively manufacturing the flow cell 418 advantageously reduces cost and procurement time and improves system flexibility.

Similar to other flow cells detailed herein, flow through the sheath fluid inlet aperture 526 is at a first flow rate and flow through the sample fluid inlet aperture 530 is a second rate lower than the first flow rate. In some embodiments, the first flow rate is approximately 30 mL/min and the second flow rate is approximately 3 mL/min. In some embodiments, a ratio of the second flow rate to the first flow rate is approximately 1:10. In some embodiments, the ratio is adjusted based on a size of samples in the sample fluid.

In some embodiments, the flow cell 418 is made of polypropylene, polycarbonate, cyclic olephin copolymer, or thermo plastic vulcanizates. In some embodiments, the flow cell 418 is a single-use device. In some embodiments, the flow cell 418 is reusable after being washed, disinfected, or some combination thereof. For example, after sorting samples from a first sample source, a cleaning solution or disinfectant is run through the flow cell 418 before sorting additional samples from a second sample source.

In the illustrated embodiment, the flow cell 418 includes a self-aligning mounting interface 554. The self-aligning mounting interface 554 advantageously allows the flow cell 418 to be easily removed and replaced with a new flow cell, either to allow for single use workflow or to allow for switching rapidly to an alternative size sample.

It is understood that the foregoing detailed description and accompanying examples are merely illustrative and are not to be taken as limitations upon the scope of the disclosure, which is defined solely by the appended claims and their equivalents. Various changes and modifications to the disclosed embodiments will be apparent to those skilled in the art. Such changes and modifications of the disclosure may be made without departing from the spirit and scope thereof.

1. A sorting system comprising:
a flow cell with a first inlet, a second inlet, and an outlet;
a buffer supply in fluid communication with the first inlet;
a sample source in fluid communication with the second inlet;
a light source configured to generate a light beam that intersects the flow cell;
a sensor aligned with the light source and configured to detect a characteristic of the light beam; and
an air valve configured to generate an airflow at the outlet of the flow cell;
wherein control of the air valve is based on the characteristic of the light beam detected by the sensor.

2. The system of claim 1, further including a sample collection stage aligned with the outlet.

3. The system of claim 2, wherein the sample collection stage includes a plate with a well; the sample source includes a sample fluid with a plurality of targets; and the sorting system is configured to place one or more of the plurality of targets in the well.

4. The system of claim 3, wherein the well is one of a plurality of wells and the sorting system is configured to place one of the plurality of targets in each of the plurality of wells.

5. The system of claim 2, wherein the sample collection stage includes an actuator coupled to the plate, wherein the plate is movable with respect to the outlet of the flow cell in response to activation of the actuator.

6. The system of claim 1, wherein the airflow moves fluid from the outlet of the flow cell to a waste collection.

7. The system of claim 6, wherein the waste collection includes a shroud and the outlet of the flow cell is positioned within the shroud.

8. The system of claim 7, wherein the shroud includes an aperture aligned with the outlet of the flow cell.

9. The system of claim 1, further including a pressure source in fluid communication with each of the buffer supply, the sample source, and the air valve.

10. The system of claim 1, wherein the light source is a laser.

11. The system of claim 1, wherein a profile of the light beam is linear.

12. The system of claim 1, wherein the sample source includes a sample fluid with a plurality of targets, the sample fluid flows from the second inlet to the outlet and passes through the light beam, wherein the plurality of targets blocks a portion of the light beam from reaching the sensor.

13. The system of claim 12, further comprising a camera configured to capture an image of the plurality of targets as the plurality of targets move through the flow cell.

14. The system of claim 1, wherein the characteristic of the light beam is transmission.

15. The system of claim 1, wherein control of the air valve is based on a time-of-flight analysis of the light characteristic.

16. The system of claim 1, wherein a flow of fluid through the flow cell is paused in response to the sensor detecting a change in the characteristic of the light beam; and a fixed amount of liquid is dispensed from the outlet of the flow cell after the pause.

17. The system of claim 1, wherein a flow rate of fluid through the flow cell is continuous.

18. The system of claim 1, further comprising a first flow sensor and a first valve fluidly positioned between the buffer supply and the flow cell, and a second flow sensor and a second valve positioned between the sample source and the flow cell.

19. The system of claim 18, wherein the first valve is controlled based on a first flow detected by the first flow sensor; and wherein the second valve is controlled based on a second flow detected by the second flow sensor.

20. The system of claim 1, further comprising a mixing assembly coupled to the sample source, wherein the mixing assembly is configured to move the sample source.

21. The system of claim 20, wherein the mixing assembly includes a base, a carrier configured to receive the sample source, and an actuator coupled to the carrier; wherein the carrier rotates about an axis in response to activation of the actuator.

22. The system of claim 21, wherein the sample source includes a protrusion configured to create a turbulent flow of a sample fluid within the sample source in response to rotation about the axis.

23. The system of claim 1, further including a lens aligned with the light beam and positioned between the light source and the flow cell.

24. The system of claim 1, wherein the sorting system is configured to sort at least 20 samples per minute.

25. The system of claim 1, further comprising a temperature-controlled system thermally coupled to the buffer supply, the sample source, the sample collection stage, or any combination thereof.

26. The system of claim 1, wherein the flow cell further includes a third inlet and the system further comprises an auxiliary supply in fluid communication with the third inlet.

27. The system of claim 26, wherein the auxiliary supply is a cleaning solution, a disinfectant, or any combination thereof.

28. The system of claim 1, further comprising an identifying fiducial coupled to the flow cell and a sensor configured to detect the identifying fiducial.

29.-65. (canceled)
